(19) United States
(12) Patent Application Publication
(10) Pub. No.: US 2007/0150580 A1
(43) Pub. Date: Jun. 28, 2007

(54) Method and device for monitoring the exchange of data between application systems

(75) Inventors: Christian W Meentzen, Grassberg (DE); Marco Monsees, Bremen (DE)

Correspondence Address: GOTTLIEB RACKMAN & REISMAN PC, 270 MADISON AVENUE, 8TH FLOOR, NEW YORK, NY, 100160601, US

(73) Assignee: Conxpert Holding GMBH, Brenmen (DE)

(21) Appl. No.: 10/585,483

(22) PCT Filed: Nov. 25, 2004
(86) PCT No.: PCT/EP04/13358

§ 371 Date: Sep. 22, 2006

(30) Foreign Application Priority Data
Jan. 8, 2004 (DE) 2004-001-323.3

(51) Int. Cl. G06F 15/173

(52) U.S. Cl. 709/224

(57) ABSTRACT

The invention affords a possible way of checking whether the transaction of a data packet from a first application system to a second application system was effected successfully and within a predetermined transaction time, even if a series of further application systems are between the two application systems, the application systems involved are of a different nature and are associated with different businesses. For that purpose in accordance with the invention there is proposed a method comprising the steps: transmitting a despatch control message from a first application system to a separate monitoring unit after despatch of a data packet from the first application system to a second application system, creating a reception control message from the second application system after successful reception of the data packet by the second application system, and outputting a monitoring message from the monitoring unit containing information as to whether the data packet was received by the second application system successfully and within a predetermined transaction time.

The present invention concerns a method and a corresponding monitoring system for monitoring the data exchange between application systems. The invention further concerns a monitoring unit for use in such a monitoring system and a monitoring method carried out by that monitoring unit. Finally the invention also concerns a computer program for executing that method on a computer.

Many businesses are increasingly implementing electronic data exchange with each other in order to achieve better efficiency in communication and thus to reduce the error rate which occurs with the methods generally used hitherto such as for example the exchange of data by telephone, fax or post. In general terms in that respect a plurality of internal and external software products and service providers are necessary in order to make the connection between one's own application system which wishes for example to despatch a data packet and external application systems which for the most part are of a quite different nature and which are to receive and process the data packet which is sent. There are various products on the market, which in such a configuration primarily implement format recognition, format validation and conversion processes and which are required for receiving or despatching data packets, wherein a data packet can in principle contain any kind of data or information. It will be noted however that those software products or service providers at best ensure the communication to the respective application system which is next in the chain, that is to say for example a software module or a service provider.

Very frequently, those data packets are relevant not only for a single application system but for a plurality of application systems within a business. Products have developed therefrom, from the area of enterprise application integration (EAI), which are additionally capable of representing processes (workflows) within a business.

The object of the present invention is to provide a method of monitoring data exchange between application systems and a corresponding monitoring system and a monitoring unit, with which businesses can guarantee in a simple fashion transaction security for business processes beyond the business limits and beyond a plurality of software products and service providers as well as application systems.

That object is attained by a method as set forth in claim 1 comprising the steps:
transmitting a despatch control message from a first application system to a separate monitoring unit after despatch of a data packet from the first application system to a second application system,
creating a reception control message from the second application system after successful reception of the data packet by the second application system, and
outputting a monitoring message from the monitoring unit containing information as to whether the data packet was received by the second application system successfully and within a predetermined transaction time.

A corresponding monitoring system is recited in claim 10. The invention further concerns a monitoring unit for use in such a monitoring system comprising:
a receiving unit for receiving a despatch control message from a first application system after despatch of a data packet from the first
application system to a second application system,
a checking unit for checking a reception control message created by the second application system after successful reception of the data packet,
a processing unit for checking whether the data packet was received by the second application system successfully and within a predetermined transaction time, on the basis of the despatch control message and reception control message and for creating a corresponding monitoring message, and
an output unit for outputting the monitoring message.

A corresponding method which is preferably carried out by that monitoring unit for monitoring the data exchange between application systems is recited in claim 13. A computer program for executing that method on a computer is recited in claim 14.

The invention is based on the notion, besides the application systems involved in the data exchange, of providing a separate monitoring unit, the task of which is to check whether a data packet despatched from a first application system was also received by the desired receiver successfully and within a predetermined transaction time. If that is not the case the monitoring unit creates and outputs a corresponding error message so that it is possible to check why that error occurred and renewed despatch can be implemented. Checking by the monitoring unit takes place on the basis of control messages which at least the despatching and also the receiving application system send to the monitoring unit or alternatively, as regards the reception control messages, are stored in the receiving application system and are periodically checked by the monitoring unit.

It is periodically provided that in any event, that is to say both with a positive and also with a negative checking result, the monitoring unit creates a monitoring message and preferably transmits it to the despatching application system. It can also be provided however that it is only in the case of a negative checking result that a corresponding monitoring message is created and outputted.

The invention makes it possible to establish with a high degree of certainty whether a transaction of a data packet between application systems has taken place correctly and as intended. That is of significance in particular if, as is provided in a preferred configuration, the first and second application systems are not directly connected together but are indirectly connected together in particular by way of at least one further application system and/or transmission system. Particularly for business processes beyond corporate limits, the invention is advantageous as it then very frequently occurs that the two application systems are completely different and in particular use different data protocols and then it is frequently not possible to establish whether a transaction occurred successfully and within a predetermined transaction time.

It also particularly frequently happens that there is a chain of further systems between the despatching application system and the receiving application system. In order in such a situation to achieve an even higher level of control in respect of the transaction and an even higher level of transaction certainty, it is provided in an embodiment that the application and transmission systems connecting the first and second application systems also create reception and/or despatch control messages after successful reception and despatch respectively of the data packet, which can then be checked by the monitoring unit. Thus in such a chain of systems it is possible to precisely monitor where a error possibly occurs so that that error can then possibly also be more easily corrected. That also makes it possible to achieve in particular a better limitation option for the error (always also in consideration of the background of consequential damage such as for example production stoppage due to non-transmission of an order, etc).

A development of the invention provides that rules concerning the transmission of data packets are predetermined in the monitoring unit, in which rules it is specified which points are to be monitored by the monitoring unit on the basis of the despatch and reception control messages. Rules of that kind can preferably be freely defined by the users. Thus for example it is possible to define therein how great the transaction time may be at a maximum in total or between adjacent application systems and which systems in a chain of participating systems send control messages in accordance with expectation. In addition such rules can establish the notification mode by the monitoring unit, that is to say who must be informed and how if a given rule is not observed.

A development further provides that measures to be taken for different kinds of data packets in a negative result of points to be monitored, maximum transaction time, transmission paths and/or application systems from which control messages are expected are specified in the rules. It will be noted however that it is not absolutely necessary for the rules to be predetermined in the monitoring unit. It is alternatively also possible for the despatching application system which transmits a despatch control message to the monitoring unit at the same time therewith also to send the corresponding monitoring rule for use by the monitoring unit.

In principle it is possible for corresponding monitoring to be effected for each individual data packet. Particularly if a plurality of interrelated data packets are despatched in succession by a despatcher to the same receiver however it is advantageous for monitoring to be effected virtually only on a random sampling basis or only in respect of individual data packets.

As already mentioned, it is preferably provided that the reception control messages are transmitted from the second application system to the monitoring unit. Alternatively however it can also be provided that the reception control messages are stored in the second application system, for example in a separate databank, and the monitoring unit periodically monitors the stored reception control messages.

The monitoring message created by the monitoring unit is preferably transmitted to the first application system so that the latter directly receives knowledge of a transmission error and same can be removed. The monitoring message however can also be transmitted to a service provider connected to the first application system or a user of the first application system, for example an employee of the corresponding business, for example by e-mail or SMS.

The invention is described in greater detail hereinafter with reference to the drawings in which:

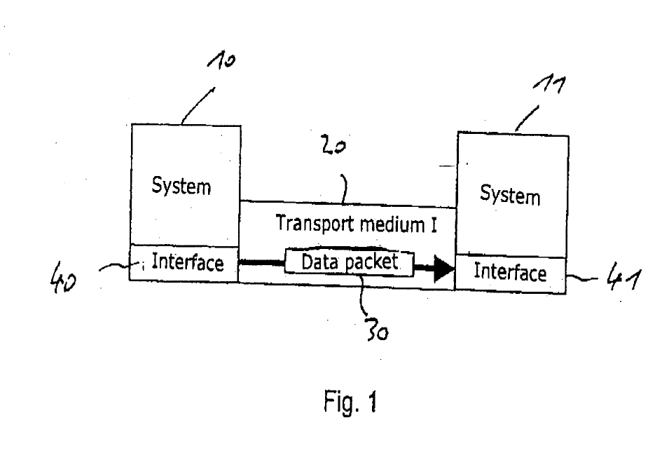

FIG. 1 shows a block circuit diagram to explain the known communication between two application systems,

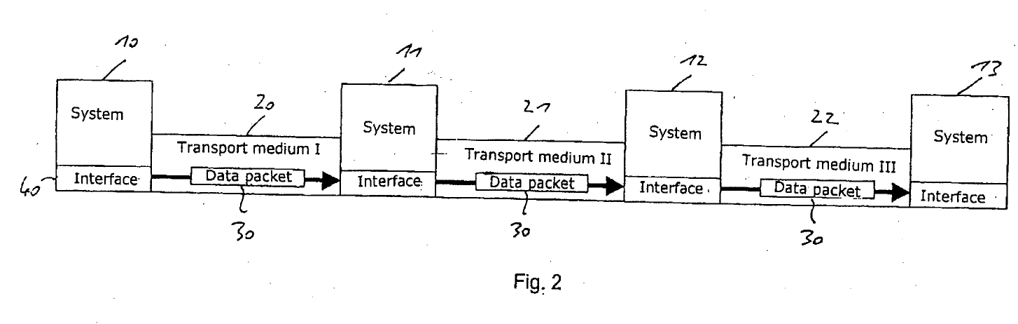

FIG. 2 shows a block circuit diagram of a chain of application systems to explain the underlying problem of the invention,

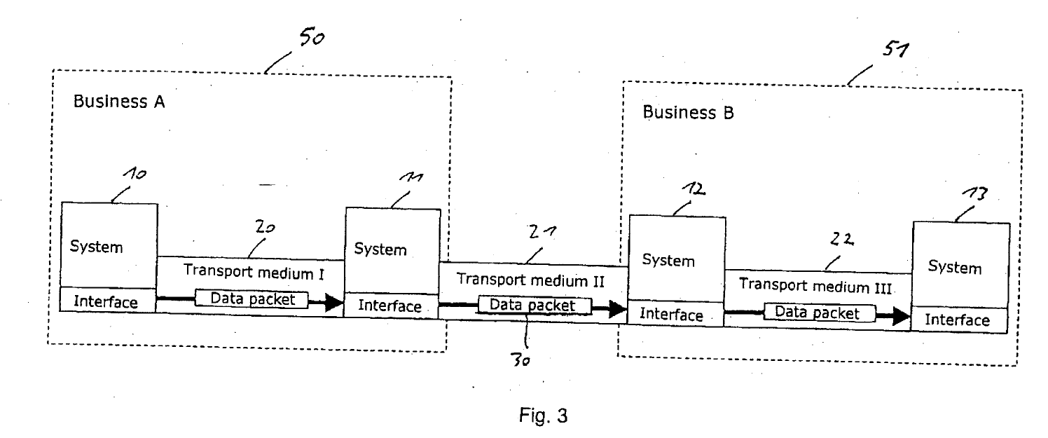

FIG. 3 shows a block circuit diagram with a plurality of application systems associated with different businesses,

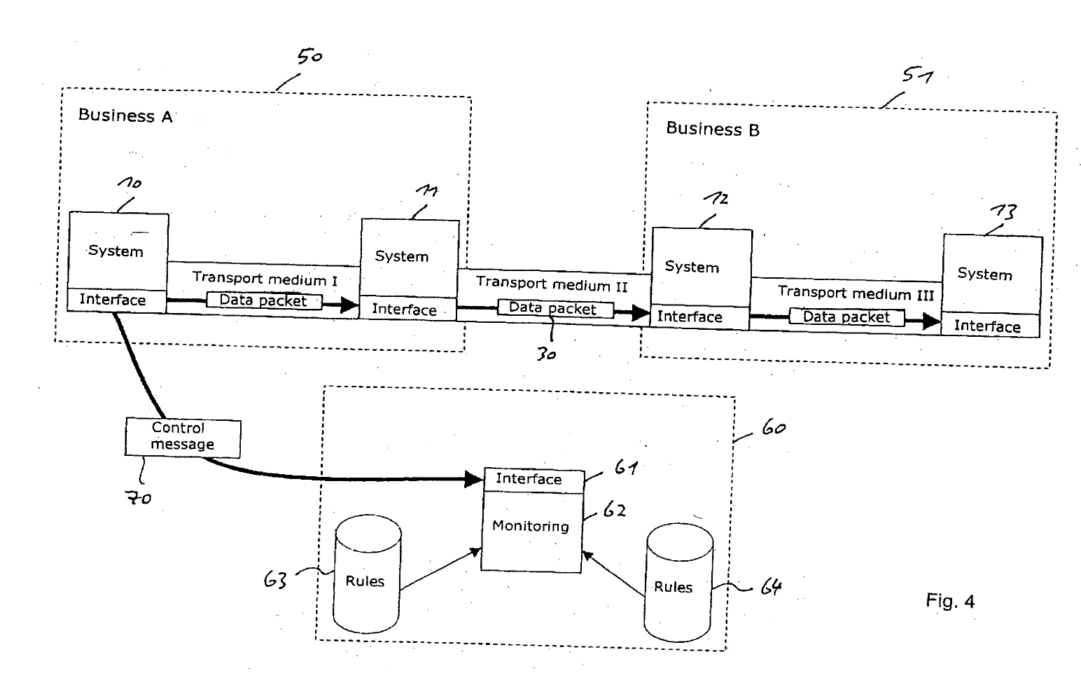

FIGS. 4 to 6 show a block circuit diagram of the monitoring system according to the invention for explaining the steps of the monitoring method according to the invention,

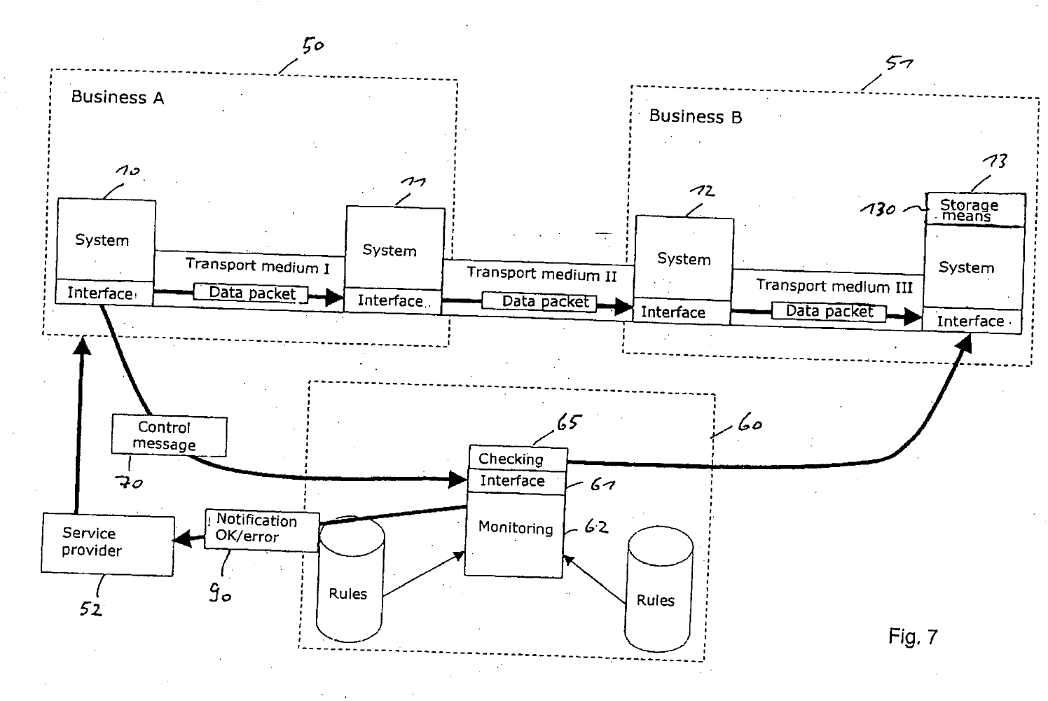

FIG. 7 shows a block circuit diagram of a further configuration of the monitoring system according to the invention, and

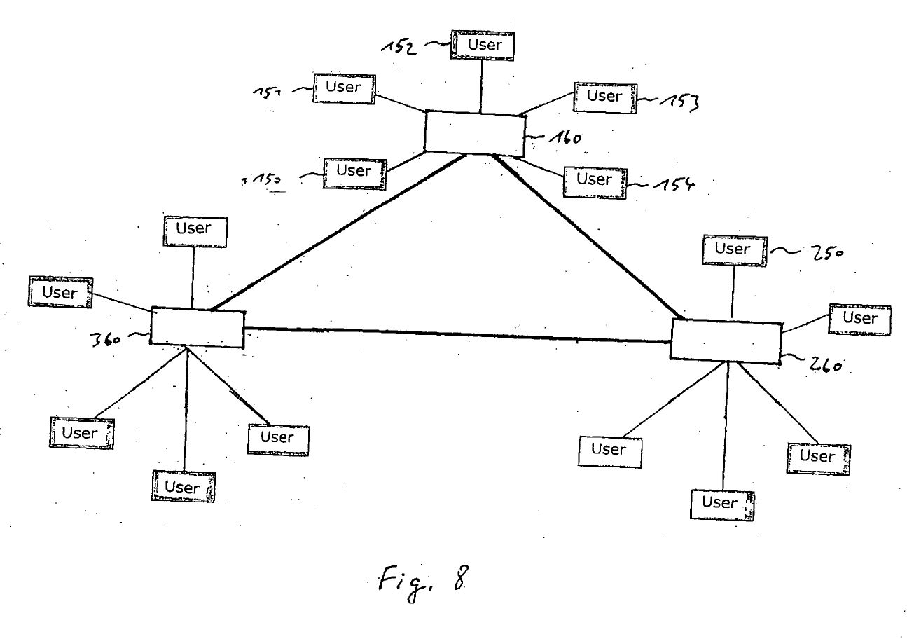

FIG. 8 shows a block circuit diagram of still a further configuration of the monitoring system according to the invention.

FIG. 1 shows two application systems 10, 11 which are directly connected together by way of a transport medium 20 and between which data are to be exchanged electronically in the form of data packets 30. The application systems 10, 11, that is to say for example software services or service providers, generally have a defined interface 40, 41 which ensures that the two application systems 10, 11 can exchange data with each other in valid format.

Those interfaces 40, 41 can always be used between precisely two application systems. As soon as a plurality of application systems are necessary for a process however, as is shown in FIG. 2, the interface 40 of the application system 10 despatching a data packet 30, particularly in the case of an asynchronous connection between the application systems 10-13, cannot guarantee whether the data packet 30 could also be processed in the intended reception application system 13 or whether it did in fact arrive there at all and possibly within a maximum predetermined transaction time. That problem can still be resolved in partial areas within a so-called EAI software. If however the chain of the application systems (10-13 in FIG. 2) exceeds the corporate limits, as is shown in FIG. 3 where the application systems 10 and 11 are associated with a first corporate business 50 and the application systems 12 and 13 are associated with a second corporate business 51, then even the commercially available products are no longer suitable for guaranteeing transaction certainty or in any way checking successful implementation of a transaction.

It should be mentioned at this point that the transport media 20, 21, 22 connecting the individual application systems 10 to 13 can be both identical and also completely different, that is to say for example can have different transmission rates and data formats.

A monitoring system according to the invention is shown in greater detail in FIGS. 4 to 6 in the form of block circuit diagrams. They each show the individual steps of the monitoring method, which are to be explained hereinafter. Irrespective of the application systems 10 to 13 associated with the individual businesses 50, 51, provided in the monitoring system according to the invention is a separate monitoring unit 60, for example a server arranged at a service provider. It has an interface 61 for the reception of control messages from the application systems and for the output of monitoring messages. There is also a processing unit 62 which, on the basis of the control messages, checks successful implementation of the transmission of a data packet and produces a corresponding monitoring message. There are also storage units 63, 64 in which are stored rules for that checking operation, which are predefined for example by users of the associated application systems.

As an example it should be explained hereinafter which steps are provided in accordance with the invention in order to monitor the transmission of a data packet 30 from the application system 10 at the first business 50 by way of application systems 11 and 12 to the application system 13 at the second business 51. FIG. 4 shows in that respect the first step whereby, after the despatch of the data packet 30 from the application system 10, a despatch control message 70 is sent to the receiving unit 61 of the monitoring unit 60. That causes a process which is in parallel with the transmission of the data packet 30 to be started up. That process has been defined beforehand by the participating businesses 50 and 51 and is provided with certain rules which are stored in the storage units 63 (in particular for the application system 10) and 64 (in particular for the application system 13). That means that the entire chain of the application systems 10 to 13 and/or service providers which are between the despatching application system 10 and the intended receiver application system 13 are thus directly or indirectly checked in respect of their function and mode of operation.

For direct checking it is therefore provided as a further step that the application systems 11 and 12 also respectively transmit reception and/or despatch control messages to the monitoring unit 60 if the data packet was successfully received or successfully passed on. In the case of indirect checking however a control message is not necessarily sent from each application system to the monitoring unit 60, but only individual application systems send corresponding control messages to the monitoring unit 60. If therefore for example the application system 12 sends a positive reception control message to the monitoring unit 60, it is assumed that the application system 11 has also operated in an error-free manner.

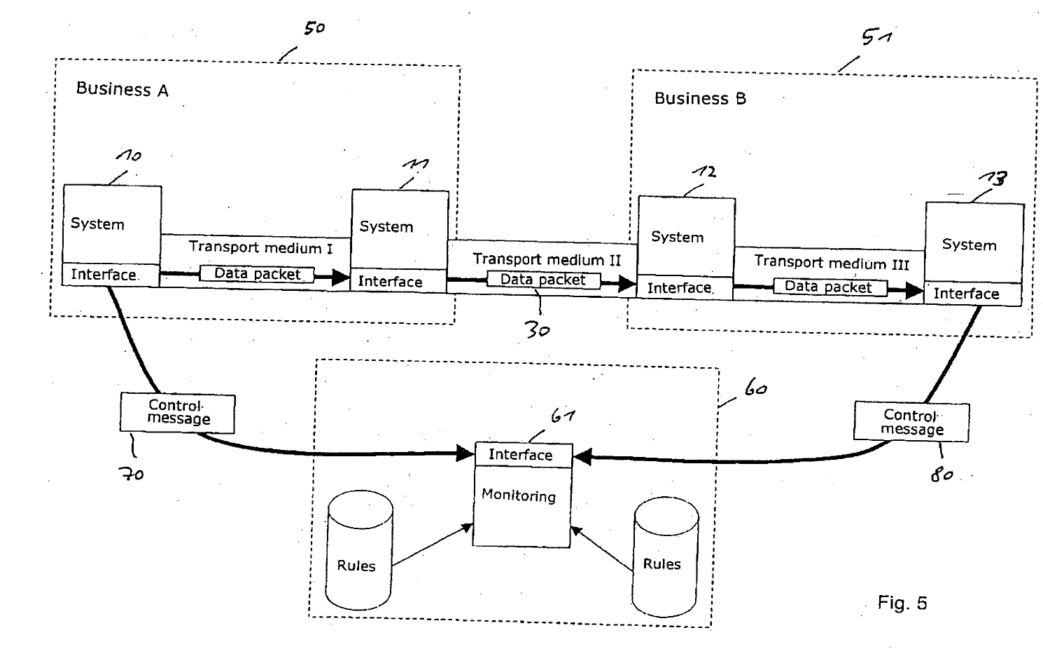

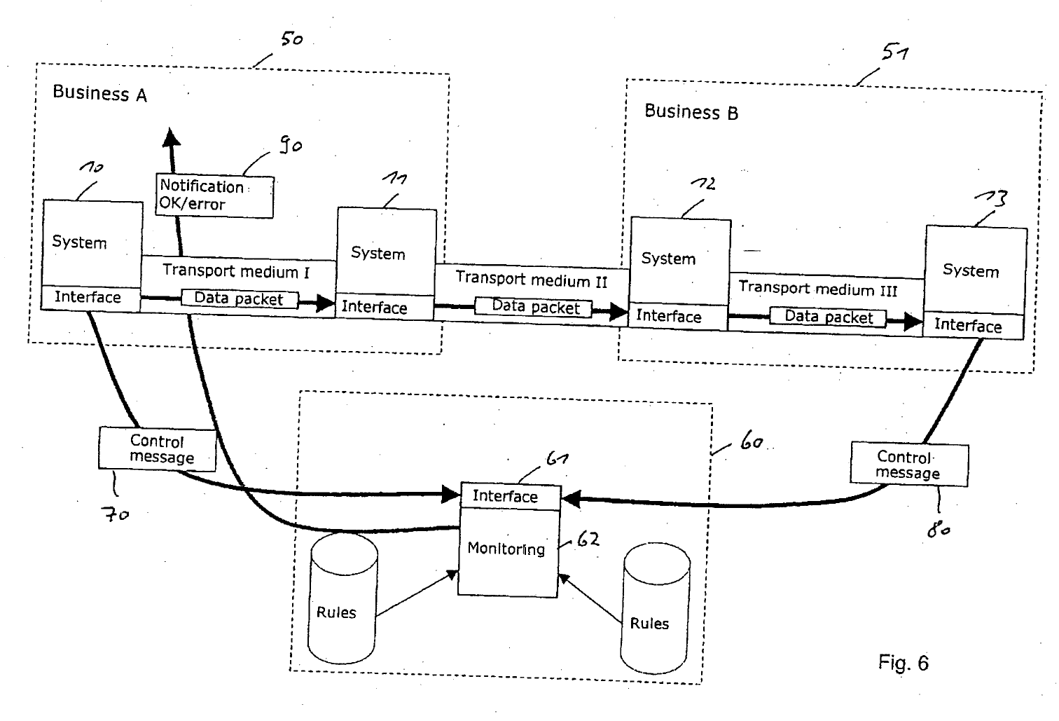

FIG. 5 shows as a further step that the application system 13 intended as the receiver, after reception of the data packet 30, transmits a reception control message 80 to the reception unit 61 of the monitoring unit 60. That can include an item of information as to whether the data packet 30 was received in error-free manner and at what time. The monitoring unit for that purpose preferably waits within given tolerance limits for a reception control message of that kind. If that message is negative or if it does not appear within the tolerance limits (that is to say for example 30 seconds after being sent from the application system 10), which is checked by the processing unit 62, the processing unit 62 generates a corresponding monitoring message 90 which is delivered for example to the despatching application system 10 or the associated business 50, as shown in FIG. 6.

That monitoring message 90 can also include information as to at which location and/or which error occurred in transmission of the data packet so that suitable measures can be taken. In addition the intended receiver application system 13 or the associated business 51 can also receive a corresponding monitoring message. Furthermore the application system 10 can be automatically requested to send the data packet again on the same path. It is also possible to start a further ‘rule tree’ if alternatives are possible.

For example the despatch system 10 may have two alternative target addresses (because for example the target system operates load balancing or an automatic failover system) which are used depending on the respective attainability of the target systems. If now the first target address is checked negatively as a priority, the second target address can be checked positively with the implementation of a further rule tree. That example uses active periodic checking of the target system; when transmitting a reception message that example would make little sense as in practice it would not be crucial for the process whether the message were generated by the first or second target system.

The entire chain of the application systems can be expanded as desired at all locations, that is to say it is often the case that not just two application systems are involved within businesses, by rather a plurality of application systems which are possibly also different. Data exchange also does not have to be restricted to two businesses but often also service companies and clearing centres which effect the conversion of data between different systems are also used as data mediators. In addition there is the possibility, as already mentioned, of monitoring intermediate steps in the same fashion, that is to say for example despatching a reception control message from each intermediate station and monitoring it by means of the monitoring unit.

In addition the reception control messages do not necessarily have to be sent to the monitoring unit but, in a further configuration as diagrammatically shown in FIG. 7, it can be provided that the monitoring unit, by means of a checking unit 65, actively and periodically checks the reception control messages stored in the databank 130 in the application system 13. In addition the monitoring message does not necessarily have to be sent to the first application system 10 but it can also be sent to a separate service provider connected to the first application system 10 or an employee 52, for example by e-mail or SMS, who can then take appropriate measures to eliminate an error.

Still a further configuration of the monitoring system according to the invention is shown in FIG. 8. In this case there are provided a plurality of (in the present case three) monitoring units 160, 260, 360 which are operated independently of each other by various service providers. Connected to each monitoring unit 160, 260, 360 are a plurality of users (corporate businesses), for example the users 150-154 to the monitoring unit 160. A business only has to be known in respect of ‘its’ monitoring unit and can nonetheless send acknowledgements to businesses which are known in relation to another monitoring unit. An example in that respect is as follows: business 150 is known in relation to monitoring unit 160 and there sets up a monitoring message for business 250 which is known in relation to the monitoring unit 260. The business 250 now sends the acknowledgement to monitoring unit 260. That establishes that the message is stored on the monitoring unit 160 or must be evaluated there and forwards it to the monitoring unit 160.

The invention provides a possible way of checking whether the transaction of a data packet from a first application system to a second application system occurred successfully and within a predetermined transaction time, even if between the two application systems there is a series of further application systems which are participating application systems of a different kind and are associated with different businesses.

1. A method of monitoring data exchange between application systems comprising the steps:
transmitting a despatch control message from a first application system to a separate monitoring unit after despatch of a data packet from the first application system to a second application system,
creating a reception control message from the second application system after successful reception of the data packet by the second application system, and
outputting a monitoring message from the monitoring unit containing information as to whether the data packet was received by the second application system successfully and within a predetermined transaction time.

2. A method according to claim 1 characterised in that the first and second application systems are not directly connected together but are indirectly connected together in particular by way of at least one further application system and/or transmission system.

3. A method according to claim 2 characterised in that the application and transmission systems connecting the first and second application systems also create reception and/or despatch control messages after successful reception and despatch respectively of the data packet and communicate same in particular to the monitoring unit.

4. A method according to [one of the preceding claims] claim 1 characterised in that the first and second application systems are different application systems and in particular use different data protocols.

5. A method according to [one of the preceding claims] claim 1 characterised in that rules concerning the transmission of data packets are predetermined in the monitoring unit, in which rules it is specified which points are to be monitored by the monitoring unit on the basis of the despatch and reception control messages.

6. A method according to claim 5 characterised in that measures to be taken for different kinds of data packets in the case of a negative result of points to be monitored, maximum transaction times, transmission paths and/or application systems from which control messages are expected are specified in the rules.

7. A method according to [one of the preceding claims] claim 1 characterised in that the reception control messages are transmitted from the second application system to the monitoring unit.

8. A method according to [one of claims 1 to 7] claim 7 characterised in that the reception control messages are stored in the second application system and the monitoring unit periodically monitors the stored reception control messages.

9. A method according to [one of the preceding claims] claim 1 characterised in that the monitoring message is transmitted to the first application system, a service provider connected to the first application system or a user of the first application system.

10. A monitoring system for monitoring the data exchange between application systems comprising:
a first application system for transmitting a despatch control message to a separate monitoring unit after despatch of a data packet from the first application system to a second application system,
a second application system for creating a reception control message after successful reception of the data packet, and
a monitoring unit for outputting a monitoring message containing information as to whether the data packet was received by the second application system successfully and within a predetermined transaction time.

11. A monitoring unit for use in a monitoring system according to claim 10 comprising:
a receiving unit for receiving a despatch control message from a first application system after despatch of a data packet from the first application system to a second application system,
a checking unit for checking a reception control message created by the second application system after successful reception of the data packet,
a processing unit for checking whether the data packet was received by the second application system successfully and within a predetermined transaction time, on the basis of the despatch control message and reception control message and for creating a corresponding monitoring message, and
an output unit for outputting the monitoring message.

12. A monitoring unit according to claim 11 and further comprising a storage unit for storing predetermined rules which relate to the transmission of data packets and in which it is defined which points are to be monitored by the monitoring unit on the basis of the despatch and reception control messages.

13. A method of monitoring the data exchange between application systems comprising the steps:
receiving a despatch control message from a first application system after despatch of a data packet from the first application system to a second application system,
checking a reception control message created by the second application system after successful reception of the data packet,
checking whether the data packet was received by the second application system successfully and within a predetermined transaction time on the basis of the despatch control message and the reception control message,
creating a corresponding monitoring message, and
outputting the monitoring message.

14. A computer program with computer program means for causing a computer to execute the steps of the method according to claim 13 when the computer program is executed on a computer.
